(19) United States
(12) Patent Application Publication
(10) Pub. No.: US 2005/0215741 A1
(43) Pub. Date: Sep. 29, 2005

(54) Fluorinated elastomers with low glass transition temperatures based on vinylidene fluoride and free of tetrafluoroethylene or siloxane group

(75) Inventors: Bruno Michel Ameduri, Montpellier (FR); Michel Armand, Montreal (CA); Mario Boucher, St-Etienne-des-Gres (CA); Bernard Leon Boutevin, Montpellier (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: HYDRO-QUEBEC, Montreal (CA)

(21) Appl. No.: 11/106,571

(22) Filed: Apr. 15, 2005

Related U.S. Application Data
(63) Continuation of application No. 10/168,523, filed on Nov. 20, 2002, now abandoned.

(30) Foreign Application Priority Data
Dec. 29, 1999 (CA) 2,293,847
Feb. 24, 2000 (CA) 2,299,614

(51) Int. Cl. C08F 16/24; C08F 216/12

(52) U.S. Cl. 526/252; 526/247; 526/255; 524/545

(57) ABSTRACT

The present invention describes synthesis of new fluorinated elastomers presenting very low glass transition temperatures, a good resistance to bases, petroleum and fuels and good properties for forming. These elastomers contain, by way of example, from 90 to 50 mole % of vinylidene fluoride (VDF) and from 10 to 50 molar % of perfluoromethyl vinyl ether (PMVE). In this precise case, they are prepared by radical copolymerisation of VDF and with PMVE in presence of various organic initiators such as for example the peroxides, the peresters or the diazo compounds.

### TECHNICAL FIELD

The present invention relates to the synthesis of new fluorinated elastomers exhibiting very low glass transition temperatures (T_{g}), a good resistance to bases, to petroleum and to fuels, along with good properties by operating. The elastomers of the invention contain, as a non limiting example, (i) from 50 to 90 mole % of vinylidene fluoride (hereafter called “VDF”) and from 10 to 50 mole % of perfluoromethyl vinyl ether (henceforth “PMVE”) or (ii) from 55 to 98 mole % of VDF and from 2 to 45% of perfluoropropyl vinyl ether (thereafter named “PPVE”) and eventually other fluorinated alkenes, as well as in the case of (i) as in the case of (ii). The invention also relates to a process for the preparation of those elastomers by a radical copolymerisation of the comonomers in the presence of various conventional organic initiators, such as peroxides, peresters, diazo compound or alkyl peroxypivalates.

### STATE OF THE ART

The fluorinated elastomers exhibit a unique combination of extremely advantageous properties. Among these, the thermal resistance, to the oxidation, to ultraviolet rays (UV), to the degradation due to the ageing, to the corrosive chemical agents and to fuels may be mentioned. Additionally, they exhibit a low tension at the surface as well as a low dielectric constant, and they resist to the absorption of water. Due to all these properties they are choice materials in various high technology applications, such as seals in the aeronautical field, semi-conductors in the microelectronic, hoses, pipes, pump casings and in diaphragms in the chemical, automotive and petroleum industries, etc.

However, vinylidene fluoride (VDF or VF₂) based elastomers are rare. Even if commercial elastomers such as Kel F®(VDF/chlorotrifluoroethylene) and Fluorel®, Dai-El®, FKM®, Technoflon®, Viton®A ou Viton®B (VDF/HFP/TFE ou VDF/HFP) exhibit good chemical and thermal resistance, their glass transition temperatures (T_{g}) are not sufficiently low. The T_{g} of the above-mentioned commercial products range generally between −10 and −20° C. The lowest value found in the literature is that of Viton®B, whose T_{g} is −26° C., which is surprising since the manufacturer claims a T_{g} varying between −5 and −15° C. for this product. In order to compete with these elastomers, the company Ausimont has proposed a copolymer VDF/F₂C=CFCF₃ (Technoflon®) resistant to flames and to oxidation but having a T_{g} lower than −26° C. and consequently the comonomer is difficult to obtain.

DuPont has proposed a new generation of elastomers containing perfluoroalkyl vinyl ether (PAVE) resistant to low temperatures. Thus, copolymers have been produced, such as tetrafluoroethylene (TFE)/perfluoromethyl vinyl ether (PMVE) (Kalrez®) copolymers, with T_{g} that does not fall below −15° C., the TFE/PMVE described in EP 0 077 998, with a T_{g} of −9° C., or the TFE/perfluoroalkylvinylether (PAVE) described in U.S. Pat. No. 4,948,853. But its is essentially the terpolymers that exhibit still lower T_{g} values. Among these, we note the terpolymer TFE/ethylene/PMVE with a T_{g} of −17° C., or the terpolymer TFE/VDF/PAVE (described in EP 0 131 308), and essentially the terpolymer TFE/VDF/PMVE (Viton GLT®) with a T_{g} of −33° C.

However, the T_{g} increases with the percentage of TFE in the polymer, resulting in inferior properties for operating. This has also been remarked in EP 0 131 308 that describes the TFE/PAVE/VDF synthesis, even if the elastomers, that are used as O-rings, exhibit very good resistance to polar solvents (see also EP 0 618 241, JP-A-3066714 Chem. Abstr., 115:73436 z).

The terpolymerisation of TFE with the PMVE and the F₂C═CF[OCF₂CF(CF₃)]ₙOC₃F₇ (Polym. J., 1985, 17, 253) resulted in elastomers with a T_{g} (from −9 to −76° C.) depending upon the value of n, which represents the number of HFPO units and depending upon the percentage of the two oxygenated comonomers.

The state of the art suggests thus that it is necessary to return to VDF based copolymers if reaching satisfactory T_{g} is expected.

In the NASA report entitled: “Development of Vulcanizable Elastomers Suitable for Use in Contact with Liquid Oxygen”, P.D. Schuman and E.C. Strump, Third Annual Summary Report, Contract no. NAS8-5352, George C. Marshall Space Flight Center, NASA, Peninsular ChemReasearch Inc. (Jun. 8, 1966). p. 33, it is suggested that the copolymerisation of VDF with a perfluoroalkyl vinyl ether of formula F₂C═CFOR_{F}(RF═CF₃, C₂F₅ and C₃F₇) initiated at very high pressures by the azobisisobutyronitrile (AIBN) (about 1 000 atm), results in fluorinated elastomers with a T_{g} ranging from −20 to −25° C. (for an elastomer containing 43% of F₂C═CFOC₂F₅) and a T_{g} of −31° C. (with 31% of F₂C═CFOC₃F₇ in the copolymer). For a composition of the copolymer in VDF/PMVE of about 50/50 that necessitates high initial quantities of PMVE (produced via a continuous process), very approximative values of the T_{g} were ranging from −32 to −38° C. The process resulting in an obtained copolymer which is difficult to work and dangerous due to the very high pressures involved. It must be noted that in this report, no characterisation result (no NMR evidence, for example) of the exact composition of the VDF/PMVE copolymer is given, and the peroxides are not mentioned as initiators. The VDF/PMVE copolymers published by the NASA were not characterised by ¹⁹F NMR and the percentages reported for the two comonomers are therefore very hypothetical. Moreover, only one copolymer has been prepared at a very high pressure (more than 1,000 atm) and from an AIBN as initiator.

U.S. Pat. No. 4,418,186 describes the emulsion copolymerisation of VDF with the perfluorovinyl ether F₂C═CFOR_{F} where R_{F} represents the CF₂CF(CF₃)OC₃F₇ group, that produces elastomers having a T_{g} ranging from −29 to −36° C. By introducing a second ether bridge, the suppleness of the copolymer is improved and the T_{g} value reduced. However, the price of the perfluoroalkyl vinyl ether used is relatively high.

EP 0 077 998 describes the solution copolymerisation (in ClCF₂CFCl₂) of VDF with perfluorovinyl ether F₂C═CF(OCF₂CF(CF₃))₂OC₃F₇ initiated by a chlorofluorinated perester. The T_{g} of the final product is of −41° C. The solvent used for the polymerisation (CFC) and the costly and dangerous to manipulate initiator constitute two significant limitations. Moreover, the synthesis of the oxygenated comonomer is particularly complex.

### DESCRIPTION OF THE INVENTION

One object of the invention is therefore to synthesize new easily fabricated elastomers not requiring dangerous experimental conditions and resulting in very low glass transition temperature (T_{g} starting with in-expensive comonomers.

Another object of the invention is to synthesize new elastomers, with the composition of copolymers known exactly and without ambiguity, that is to say, with known molar percentages of the comonomers in the copolymers.

A further object of the present invention is a process for the synthesis of elastomers comprising a first comonomer, the vinylidene fluoride (VDF), and a second comonomer, a perfluorinated vinyl ether, such as, perfluoroalkyl vinyl ether and/or a perfluoroalkoxyalkyl vinyl ether, and eventually other fluorinated alkenes.

The invention relates to a process for preparing fluorinated elastomers by copolymerization of vinylidene fluoride with at least one perfluorinated vinyl ether and eventually with at least one fluorinated alkene, characterised in that the preparation is conducted by a radical copolyrmerisation in presence of an organic initiator at a temperature between 20 and 200° C., for a period of time between 3 and 15 hours, and at an initial pressure between 2 and 100 bars, and the initial pressure is allowed to drop while the monomers are progressively consumed.

The invention relates also to fluorinated elastomers comprising fluorinated vinylidene copolymers, at least one perfluorinated vinyl ether and optionally a fluorinated alkene, characterised in that it contains neither tetrafluoroethylene, nor a monomer bearing a siloxane group and having a low glass tr ansition temperatures (T_{g}) comprised between −35 and −42° C.

In a preferred embodiment, the VDF is predominant in the elastomer composition. A molar concentration of VDF between 50 to 90% is particularly preferred. As a second comonomer, a perfluoroalkyl vinyl ether such as the perfluoromethyl vinyl ether (PMVE) or the perfluoropropyl vinyl ether (PPVE) represent a preferred compound. The molar concentration of this second comonomer should preferably vary between 10% and 50% in the PMVE case and from 2 to 45% in the PPVE case.

### DETAILED DESCRIPTION OF THE INVENTION

Having regard with the state of the art, the VDF has been selected for the preparation of the elastomer according to the present invention, the latter being an alkene that is less expensive and easier to operate than the TFE. Being less expensive, it may be used in a greater quantity in the copolymer, that can contain as second a monomer, a perfluorovinyl ether such as the PMVE or the PPVE, monomers that are less expensive than the perfluoroalkoxy alkyl vinyl ethers, in order to prepare new and original elastomers exhibiting a good resistance at low temperatures and good properties in operating.

The present invention relates therefore to the synthesis of new fluorinated elastomers copolymers, based on vinylidene fluoride (VDF) and containing a perfluorinated vinyl ether, such as a perfluoroalkyl vinyl ether and/or a perfluoroalkoxyalkyl vinyl ether. Other fluorinated alkenes may be eventually added. Among the remarkable advantages of the present invention, it may be noted:
a synthesis from VDF instead of the conventional tetrafluoroethylene (TFE), the latter being naturally used for the preparation of fluorinated elastomers. The direct consequence of this substitution being reduced costs for the produced elastomers.
the synthesis of fluorinated elastomers according to the present invention does not necessitate the use of monomers bearing siloxane groups, the latter resulting generally in a decrease of the T_{g}. In fact, It is well known that the siloxanes have very low T_{g}. For example, the poly(dimethyl siloxane) has a T_{g} of −120° C. as mentionned generally in the following book: The siloxane bond: physical properties and chemical transformations, M. G. Voronkov, V. P. Mileshkevich, and Yu. A. Yuzhelevskii, Consultants Bureau, New York (1978).
the fluorinated elastomers of the present invention exhibit very low T_{g} which generally range from −35 to −45 ° C. These elastomers may thus find applications in the plastic industry as operating agent, or in other high tech industries such as aerospace, electronic or automotive, petroleum industries, or in the transportation of very cold fluids such as liquid nitrogen, liquid oxygen and liquid hydrogen. Moreover, seals with a high thermal resistance may be prepared from the elastomers according to the present invention. The fluorinated elastomers obtained by the present invention are essentially composed from VDF and a minor portion of from perfluoroalkyl vinyl ether or perfluoroalkoxyalkyl vinyl ether, and therefore less expensive.

The field of the present invention extends to all types of radical polymerisation generally used: the emulsion, miniemulsion, microemulsion, mass, suspension, microsuspension and solution polymerisation. All may be used according to conventional means, however solution polymerisation has been used preferentially, uniquely to simplify laboratory operations, because in the case of solution polymerisation, the operating pressures are fairly low, in fact about 20 to 40 bars. In the case of the emulsion polymerisation, in mass and in suspension, the operating pressure is higher, about 40 to 100 bars

The various fluorinated alkenes eventually used according to the invention have preferably no more than four carbon atoms and the structure R₁R₂C═CR₃R₄ wherein the substituents R₁₋₄ are such that at least one of them is fluorinated or perfluorinated. Among the alkenes that can be mentioned are vinyl fluoride (VF), terfluoroethylene, chlorotrifluoroethylene (CTFE), bromotrifluoroethylene, 1-hydropentafluoropropylene, hexafluoropropene, hexafluoroisobutylene, 3,3,3-trifluoropropene, 2-hydropentafluoropropylene, 1,2-dichlorodifluoroethylene, 2-chloro-1,1-difluoroethylene and generally all the fluorinated or perfluorinated vinyl compounds. Moreover, perfluorovinyl ethers may also be used as comonomers. Among them, the perfluoroalkyl vinyl ethers (PAVE) wherein the alkyl group has from one to three carbon atoms: for example, the perfluoromethyl vinyl ether (PMVE), the perfluoroethyl vinyl ether (PEVE) and the perfluoropropyl vinyl ether (PPVE). These monomers may also be perfluoroalkoxy alkyl vinyl ethers (PAAVE), described in U.S. Pat. No. 3,291,843 and in the periodical Prog Polym. Sci., 1989, 14, 251, such as perfluoro (2-n-propoxy)-propylvinyl ether, the perfluoro-(2-methoxy)-propyl-vinyl ether; the perfluoro(3-methoxy) propyl vinyl ether, perfluoro-(2-methoxy)-ethyl vinyl ether; le perfluoro-(3,6,9- trioxa-5,8-dimethyl) dodeca- 1 -ene, perfluoro-(5-methyl-3 ,6-dioxo)-1 -nonene. Mixtures of PAVE and PAAVE may also be present in the copolymers.

The preferred solvents for conducting the polymerisation in solution are advantageously conventional solvents comprising:
esters of formula R-COOR′ wherein R and R′ are independently a C₁₋₅ alkyl group, or ester group OR″ wherein R″ is an alkyl containing from 1 to 5 carbon atoms, R may also represent H. Preferably, R=H or CH₃ and R′=CH₃, C₂H₅, iC₃H₇ ou t-C₄H₉.
the fluorinated solvents of the ClCF₂CFCl₂ type, the perfluoro-n-hexane (C₆F₁₄), n-C₄F₁₀, the perfluoro-2-butyltetrahydrofuran (FC 75™); and
the usual solvents such as acetone, methyl acetate, 1,2-dichloroethane, isopropanol, tertiary butanol, acetonitrile and butyronitrile.

The preferred solvents are methyl acetate and acetonitrile in variable quantities which are usually comprised between 30 and 60 weight %.

The temperature of the copolymerisation reaction lies preferably between 20 and 200° C., more advantageously between 40 and 80° C. The pressure inside the polymerisation vessel ranges preferably between 2 and 100 bars, advantageously between 20 and 40 bars, according to the experimental conditions. Despite the above mentioned ranges are given as a matter of indication, any person of the art would be able to realise the suitable changes having regard to the properties searched for the elastomers.

In the process according to the invention, the polymerisation may be initiated by using the initiators commonly used for radical polymerisation. Representative examples of such initiators are azo compounds (such as the AIBN), dialkyl peroxydicarbonates, acetylcyclohexanesulfonyl peroxide, dibenzoyl peroxide, alkyl peroxides, alkyl hydroperoxides, dicumyl peroxides, t-alkyl perbenzoates and t-alkyl peroxypivalates. However, alkyl peroxides such as t-butyl peroxide, dialkyl peroxydicarbonates, such as diethyl peroxydicarbonates and di-isopropyl and t-alkyl peroxypivalates such as t-butyl peroxypivalates and t-amyl and, more particularly, t-alkyl peroxypivalates are preferred.

For the emulsion polymerisation process, a large range of cosolvents may be considered, the solvents are present, in various proportions, in the mixture with water, preferably from 30 to 70% in weight.

The same way, anionic surfactants, cationic or non ionic surfactants may be used in quantities ranging usually from 1 to 3 weight %. In the emulsion polymerisation process, or in suspension, water is generally used as a reaction mixture. However, the fluorinated monomers have low solubility in water, it is necessary to use surfactants. Moreover, in the emulsion or in the suspension polymerisation process, a cosolvent may be added to increase the solubility of the fluorinated comonomers. In the latter case, acetone or alkyl alkyl ketones such as methyl ethyl ketone may, as a matter of example, are used.

As an alternative to microemulsion polymerisation process, such as those described in EP 0 250 767 or dispersion polymerisation processes, as taught by U.S. Pat. No. 4,789,717; EP 0 196 904; EP 0 280 312 and EP 0 360 292, may be considered.

Chain transfer agents may also be used in order to decrease the molar weight of the copolymers. Among these, telogens containing bromide or iodide terminal atoms such as, for example, compounds of the type R_{F}X (wherein R_{F} is a perfluorinated group R_{F}=CₙF₂ₙ₊₁, n=1-10, X representing a iodide or bromide atom) may be mentioned. An exhaustive list of various transfer agents used in telomerisation of fluorinated monomers may be found in Topics in Current Chemistry, 1997, 192, 165.

In the case wherein the elastomers of the present invention would contain iodide and/or bromide atoms at terminal position, these elastomers may be reticulated (or vulcanized) by using peroxide. Well known peroxide systems, for example, those described in EP 0 136 596, may complete this task. The vulcanisation of the elastomers may also be performed by using conventional ionic methods such as those described in U.S. Pat. No. 3,876,654; U.S. Pat. No. 4,259,463; EP 0 335 705 or in the periodical Prog. Polym. Sci., 1989, 14, 251 or in “Fluoroelastomers. A.V. Cleeff, in Modem Fluoropolymer. Edited by John Scheirs. John Wiley & Sons, New York, 1997 pp. 597-614.”

A complete range of percentages of the various copolymers that could be synthesised from the employed fluorinated monomers and leading to the production of fluorinated co- and ter-polymers was studied. These numerous essays were performed starting with various initial molar ratios of the two comonomers, and in each case, the polymerisation was successful.

The analysis of the elastomers of the present invention, conducted by ¹⁹F and proton NMR spectroscopy, eventually, showed without ambiguity the molar percentages of the comonomers introduced in the products. For example, in the following Table 1, the relationship between the characteristic signals of the copolymers VDF/PMVE in ¹⁹F NMR and the structures of the products has been established.

The molar percentages of VDF in the copolymers have been determined by using the following relation:

$$\% VDF = \frac{( {I}_{- 91} + {I}_{- 92} + {I}_{- 94} + {I}_{- 95} + {I}_{- 108} + {I}_{- 110} + {I}_{- 112} + {I}_{- 113} + {I}_{- 116} )}{( {I}_{- 91} + {I}_{- 92} + {I}_{- 94} + {I}_{- 95} + {I}_{- 108} + {I}_{- 110} + {I}_{- 112} + {I}_{- 113} + {I}_{- 116} ) + ( {I}_{- 117} + {I}_{120} + {I}_{- 122} )}$$

wherein I₋ᵢ is the value of the integration of the signal situated at −i ppm in the NRM of ¹⁹F spectrum.

TABLE 1
Characterization by NMR of ¹⁹F of the VDF/PMVE copolymers

| | Chemical |
|---|---|
| | displacement |
| Structure | (ppm) |
| —CH₂CF₂—CF₂CF(OCF₃)—CH₂CF₂— | −52 |
| tBuOCF(OCF₃)CF₂— | −59 |
| —CH₂CF₂—CH₂CF₂—CH₂CF₂— | −91 |
| —CH₂CF₂—CH₂CF₂—CF₂CF(OCF₃)—CH₂CF₂— | −92; −94 |
| CH₂CF₂— | −95 |
| —CH₂CF₂—CH₂CF₂—CF₂CH₂— | −108 |
| —CF₂CF(OCF₃)—CH₂CF₂—CF₂CF(OCF₃)— | −110 |
| —CH₂CF₂—CF₂CF(OCF₃)—CH₂CF₂— | −112 |
| tBuOCH₂CF₂—CH₂CF₂— | −113 |
| —CH₂CF₂—CF₂CH₂—CF₂CH₂— | −116 |
| —CH₂CF₂—CF₂CH₂—CH₂CF₂— | −117 |
| —CF₂CF(OCF₃)—CF₂CF(OCF₃)— | −120 |
| —CF₂CF(OCF₃)—CH₂CF₂—CF₂CF(OCF₃)— | −122 |
| CH₂CF₂— | −125 |
| —CH₂CF₂—CF₂CF(OCF₃)—CH₂CF₂— | −126 |
| —CH₂CF₂—CF₂CF(OCF₃)—CH₂CF₂— | −136 |
| —CH₂CF₂—CF₂CF(OCF₃)—CF₂CH₂— | −144 |
| —CH₂CF₂—CF(OCF₃)CF₂—CH₂CF₂— | −145 |
| —CH₂CF₂—CF(OCF₃)CF₂—CH₂CF₂— | |
| —CH₂CF₂—CF₂CF(OCF₃)—CF₂CH₂— | |

The copolymers of the present invention may be used in the production of O-rings, pump casings, diaphragms having very good resistance to fuels, gasoline, t-butyl methyl ether, to alcohols and to motor oil, combined with good elastomeric properties, more particularly with a very good resistance at low temperatures. The T_{g} of the copolymers obtained ranges from −35 to −42° C. (see Table 2). Those copolymers also have the advantage that they can cross-linked in presence of conventionally used agents.

The analysis of the above Table 1 highlights the sequence head-to-tail and head-to-head of the VDF unit blocks (respectively at −91 and −113, −116 ppm) as well as short blocks with two consecutive PMVE units (for high initial PMVE proportion).

The present process comprises therefore a few interesting advantages, that are:
it is conduc0ted in a batch mode;
it is conducted in solution using classical organic solvents which are commercially available;
it consists of a radicalar polymerisation in presence of classical initiators also commercially available;
the monomer which is essentially present in the composition of the fluorinated elastomers is the VDF, is far less expensive and far less dangerous than TFE.

The following examples are only given to illustrate some preferred embodiments of the invention and should in no way be considered as limiting the scope of the present invention.

### EXAMPLE 1

### VDF/PMVE Copolymerisation (Initial Molar Percentages 80.0/20.0)

A Carius tube of borosilicate glass of considerable thickness (length=130 mm; interior diameter=10 mm; thickness=2,5 mm; of total volume of 8 cm³) containing 0.0242 g (0.104 mmol) of t-butyl peroxypivalate at 75% and 2.542 g (34.4 mmol) of methyl acetate, is connected to a vacuum system and purged three times with helium through primary vacuum cycles (100 mm Hg)/helium. Then, after at least five freeze/thaw cycles (respectively in liquid nitrogen and methanol) in order to eliminate dissolved oxygen from solution, vinylidene fluoride (VDF) (ΔP=0.35 bar, 0.525 g, 8.20 mmol) and perfluorovinylmethyl ether (PMVE), (ΔP=0.085 bar, 0.3405 g, 2.05 mmol) are successively introduced into the gas phase and trapped under vacuum in the tube frozen with liquid nitrogen, after expansion of the gas present in the metallic tank which is calibrated for the pressure. The respective amounts of gas (±8 mg precision) introduced in the tube are determined by a relative drop of the pressure inside the expansion tank, that is initially filled with a cylinder containing 300 g de VDF or 50 g of PMVE. Before this, two calibration curves “mass (of VDF or of PMVE) (in g) as a function of the pressure drop (in bar)” are determined. For example, for 0.750 g of VDF, a pressure difference of 0.50 bar is necessary when a difference of pressure of 0.20 bar is sufficient for introducing 0.0850 g of PMVE. The tube, under vacuum is again immersed, in liquid nitrogen, and sealed with a blowtorch then agitated inside of an oven at 75° C. for 13 hours.

After copolymerisation, the tube is frozen in liquid nitrogen then connected to the vacuum system hermetically, opened, and the gas that has not reacted is captured in a metallic trap that has been tarred beforehand and immersed in liquid nitrogen. 0.044 g of gas that had not reacted was trapped. This allows the calculation of the overall mass conversion rate for the gas according to the following expression:

$$\frac{{m}_{VDF} + {m}_{PMVE} - 0 \text{,} 044}{{m}_{VDF} + {m}_{PMVE}} = 95 \%$$

wherein mᵢ represents the mass of the gas i initially introduced.

Then, the yellowish liquid obtained is added dropwise in 35 mL of vigorously agitated cold pentane. After one hour at the temperature between 0-5° C., the mixture is poured into a separatory funnel and decanted. The clear colourless supernatant is removed while the yellow heavy phase is dried at 70° C. under 1 mmHg pressure, for 2 hours. 0.80 g of a very viscous and clear liquid is obtained.

The composition of the copolymer (that is to say the molar percentages of the two comonomers in the copolymer) have been determined by NMR of ¹⁹F (200 or 250 MHz) at ambiant temperature, the acetone or the deuterated DMF being the reference solvents. The reference in NMR of ¹⁹F is CFCl₃. The experimental conditions for the NMR were as follows: a flip angle of 30°, a collection time of 0.7 s, a pulse time which is of 5 s, 128 accumulation scans and a pulse width of 5 μs.

By way of example, the different NMR ¹⁹F spectrum signals and their attributes are given in the Table 1 above. According to integrated signals corresponding to each of the comonomers, the respective molar percentages VDF/PMVE are 86.6/13.4. The copolymer has the appearance of a colourless resin. The T_{g} measured is of −41.4° C. The thermogravimetric analysis (TGA), in air, reveals that the copolymer loses about 5% of its mass at 380° C.

### EXAMPLE 2

### VDF/PMVE Copolymerisation (Initial Molar Percentages 65.4/34.6).

Under the same conditions as before, a Carius tube containing 0.525 g (8.20 mmol) of VDF; 0.720 g (4.33 mmol) of PMVE; 0.0312 g (0.13 mmol) of t-butyl peroxypivalate and 2.718 g of methyl acetate are agitated at 75° C. for 6 hours. After the same treatment and drying, 1.1 g of a very viscous elastomer have been obtained and the features thereby observed in the ¹⁹F NMR spectrum show a copolymer with a molar composition VDF/PMVE equal to 79.4/20.6. The T_{g} is measured at −37.8° C. The thermogravimetric analysis (TGA), performed under air, shows that the copolymer loses about 5% of its mass at 355° C.

The Examples 1 and 2 as described above are summarized in Table 2. The same table also shows concisely Examples 3, 4 and 5. In brief, Table 2 brings together the information corresponding to the synthesis and to the thermal properties of VDF/PMVE copolymers.

TABLE 2
Operating conditions and results of the radical copolymerisation of VDF and
of PMVE

| | Example 1 | Example 2 | Example 3 | Example 4 | Example 5 |
|---|---|---|---|---|---|
| Solvent (g) | 2.542 | 2.718 | 2.478 | 2.234 | 2.280 |
| VDF (g) | 0.525 | 0.525 | 0.525 | 0.300 | 0.150 |
| PMVE (g) | 0.3405 | 0.720 | 1.320 | 1.060 | 1.560 |
| initiator (g) | 0.0242 | 0.0312 | 0.0397 | 0.0378 | 0.0366 |
| VDF initial molar % | 80.0 | 65.4 | 50.9 | 41.9 | 20.0 |
| PMVE initial molar % | 20.0 | 34.6 | 49.2 | 58.1 | 80.0 |
| C₀ (%)* | 1.02 | 1.07 | 1.06 | 1.46 | 1.34 |
| Conditions h/° C. | 13/75 | 13/75 | 13/75 | 15/75 | 15/75 |
| monomer conversion (%) | 95 | 98 | 99 | 90 | 48 |
| Copolymer | | | | | |
| molar VDF % | 86.6 | 79.4 | 73.6 | 66.3 | 61.8 |
| molar PMVE % | 13.4 | 20.6 | 26.4 | 33.7 | 38.2 |
| T_{g} (° C.) | −41.4 | −37.8 | −37.0 | −36.2 | −35.1 |

*C₀ = [initiator]₀/([VDF]₀ + [PMVE]₀). The value of C₀ ranges generally from 0.1 to 2%.

It is clear that VDF is more reactive than PMVE, this means that VDF incorporates better into the copolymer. Thus, the molar percentage of VDF in the copolymer is higher than the initial molar percentage of VDF introduced into the reactor. In each case of polymerisation, the yield is greater than 80%. These results show that the PMVE is difficult to homopolymerise and that the introduction of VDF allows its incorporation into a copolymer. This compound is formed by PVDF blocks separated by a PMVE unit. The PMVE units in the polymer, due to their —OCF₃ lateral functions, reduce and even eliminate the crystallinity, producing an amorphous compound and elastomer with a low T_{g}. The reactivity rates have been calculated for the VDF/PMVE copolymers, r_{VDF}=3,4 and r_{PMVE}=0. The two reactivity rates have been calculated according to the Tidwell and Mortimer rule, J Polym. Sci. Part A, 1965, 3, 369, at low monomer conversion rates.

### EXAMPLES 6 to 15

### VDF/PPVE Copolymerisation

The present example describes the VDF copolymerisation with a perfluoropropyl vinyl ether (PPVE), of formula CF₂═CFOC₃F₇. The radical copolymerisation in solution are realised in a Carius tube of a considerable thickness described in above examples 1 and 2. Tertiary butyl peroxide, (CH₃)₃C—O—O—C(CH₃)₃ is used as an initiator. Acetonitrile which is used as a solvent is known to be a good solvent for the monomers, and non- transferring. The copolymerisation is conducted at 120° C. for 16 hours. Several experiments are carried out using different initial molar percentages for VDF and PPVE as indicated in Table 3. After the reaction, as in the preceeding examples, the VDF/PPVE copolymer obtained, in reaction broth, is precipitated in the cold pentane (0-5° C.) which is vigorously agitated. As above, the copolymers are in the form of viscous oils. They are then characterised by ¹⁹F NMR. Table 3 brings together the results and reports the glass transition temperatures (T_{g}) that have been measured.

The microstructures of these copolymers have been perfectly characterised from the signal of the different groups attributed to the VDF and PPVE units, i.e. the same chemical displacements as those presented in Table 1 with the difference that no signals appear at −52 ppm, yet the following signals are present: at: −81 ppm for CF₃CF₂CF₂O—; −129 ppm for CF₃CF₂CF₂O—; −78 ppm for CF₃CF₂CF₂O—.

TABLE 3
Experimental results for the radical copolymerisation
of VDF and PPVE

| | | | VDF | |
|---|---|---|---|---|
| | initial VDF | C₀* | copolymer | T_{g} |
| Example | (molar %) | (×10⁻³) | (molar %) | (° C.) |
| 6 | 94.8 | 1.0 | 97.3 | −38.9 |
| 7 | 83.4 | 1.4 | 86.3 | −36.1 |
| 8 | 70.1 | 1.3 | 80.3 | −34.6 |
| 9 | 65.2 | 1.6 | 77.5 | −35.3 |
| 10 | 57.2 | 1.4 | 75.1 | −32.4 |
| 11 | 50.1 | 1.4 | 73.3 | −28.7 |
| 12 | 39.9 | 1.6 | 64.6 | −27.5 |
| 13 | 29.7 | 1.0 | 61.1 | −24.7 |
| 14 | 20.4 | 1.0 | 57.0 | −24.4 |
| 15 | 11.0 | 1.4 | 56.0 | −22.8 |

*C₀ = [initiator]₀/([VDF]₀ + [PPVE]₀)

The VDF percentage in the copolymer mentioned in Table 3 is determined from the following equation:

$$\% VDF = \frac{( {I}_{- 91} + {I}_{- 92} + {I}_{- 94} + {I}_{- 95} + {I}_{- 108} + {I}_{- 110} + {I}_{- 112} + {I}_{- 113} + {I}_{- 116} )}{( {I}_{- 91} + {I}_{- 92} + {I}_{- 94} + {I}_{- 95} + {I}_{- 108} + {I}_{- 110} + {I}_{- 112} + {I}_{- 113} + {I}_{- 116} ) + ( {I}_{129} )}$$

wherein I₋ᵢ is the integration value of the signal situated at −i ppm on the ¹⁹F NMR spectrum.

Contrary to the copolymers of the previous examples, there are never two consecutive PPVE units in this copolymer. This is essentially due to the sterical hindrance of the perfluoroproproxy group. The reactivity rates have been calculated for the VDF/PPVE copolymers, they are r_{VDF}=1.15±0.36 and r_{PPVE}=0. These reactivity rates have been determined according to the Tidwell and Mortimer rule, J Polym. Sci. Part A, 1965, 3, 369.

Although the present invention has been described through specific embodiments, it is understood that many variations and modifications can be attached to these embodiments, and the present disclosure aims to cover such modifications, uses or adaptations of the present invention following, in general, the principles of the invention and, including all variations of the present description which become known or accepted practice in the field of activity where the present invention is found, and may be applied to other essential elements mentioned below, and in agreement with the breath of the following claims.

1. Process for fluorinated elastomers preparation by copolymerisation of vinylidene fluoride with at least one perfluorinated vinyl ether and optionally with at least one fluorinated alkene, characterized in that the preparation is conducted by a radical copolymerisation with an organic initiator at a temperature between 20 and 200° C., for a period of time between 3 and 15 hours, at an initial pressure between 2 and 100 bars, and an initial pressure that is allowed to drop progressively as the monomers are consumed.

2. Process according to claim 1, wherein the perfluorinated vinyl ether is selected from the group consisting of perfluoroalkyl vinyl ether, perfluoroalkoxyalkyl vinyl ether and a mixture thereof.

3. Process according to claim 1, wherein 50 to 90 mole % of fluorinated vinylidene is used, the remaining being constituted by perfluorinated vinyl ether and optionally at least one fluorinated alkene.

4. Process according to claim 3, wherein the perfluorinated vinyl ether is used for 10 to 50 mole %.

5. Process according to claim 2, wherein the vinyl ether is a perfluoroalkyl vinyl ether selected from the group consisting of perfluoromethyl vinyl ether, perfluoroethyl vinyl ether and perfluoropropyl vinyl ether.

6. Process according to claim 5, wherein the perfluorinated vinyl ether is perfluomethyl vinyl ether or perfluoropropyl vinyl ether.

7. Process according to claim 2, wherein the vinyl ether is a perfluoroalkoxyalkyl vinyl ether selected from a group consisting of perfluoro-(2-n-propoxy)-propyl vinyl ether, perfluoro-(2-methoxy)-propyl vinyl ether, perfluoro-(3-methoxy)-propyl vinyl ether, perfluoro-(2-methoxy)-ethyl vinyl ether, perfluoro-(3,6,9-trioxa-5,8-dimethyl) dodeca-1-ene and perfluoro-(5-methyl-3,6-dioxa)-1-nonene, alone or in a mixture.

8. Process according to claim 1, wherein the radical copolymerisation is performed in solution in the presence of a solvent.

9. Process according to claim 7, wherein the solvent is selected from the group consisting of:
the esters of formula R—COOR′ wherein R and R″ independently represent C₁₋₅ alkyl or a OR″ group wherein R″ represents an alkyl group containing from 1 to 5 carbon atoms, R may also represent H,
fluorinated solvents including perfluoro-n-hexane,
the solvents selected from the group consisting of methyl acetate, acetone, 1,2-dichloroethane, isopropanol, tertiary butanol, acetonitrile and butyronitrile.

10. Process according to claim 9, wherein R=H or CH₃ and R′=CH₃, C₂H₅, iC₃H₇ or t-C₄H₉.

11. Process according to claim 9, wherein the solvent is a fluorinated solvent selected from the group consisting of ClCF₂CFCl₂, n-C₆F₁₄, n-C₄F₁₀ and the perfluoro-2-butyltetrahydrofuran.

12. Process according to claim 9, wherein the solvent is selected from a group consisting of methyl acetate and acetonitrile.

13. Process according to claim 1, wherein the temperature is between 40 and 80° C.

14. Process according to claim 1, wherein the initial pressure is between 20 and 100 bars.

15. Process according to claim 1, wherein the radical copolymerisation is conducted by emulsion, miniemulsion, microemulsion, mass, suspension and microsuspension or solution polymerisation.

16. Process according to claim 1, wherein vinylidene fluoride copolymerisation is performed, with at least one perfluorinated vinyl ether and with at least one fluorinated alkene, the fluorinated alkene is a compound of structure R₁R₂C═CR₃R₄ wherein R₁, R₂, R₃ and R₄ are such that at least one of them is fluorinated or perfluorinated.

17. Process according to claim 1, wherein the fluorinated alkene is selected from the group comprising of vinyl fluoride, trifluoroethylene, chlorotrifluoroethylene, bromotrifluoroethylene, 1-hydropentafluoropropylene, hexafluoropropene, hexafluoroisobutylene, 3,3,3-trifluoropropene, and 2-hydropentafluoropropylene.

18. Process according to claim 1, wherein the copolymerisation of the vinylidene fluoride with the perfluoromethyl vinyl ether and/or with the perfluoropropyl vinyl ether is performed.

19. Process according to claim 18, wherein 60 to 90 mole % of vinylidene fluoride and 40 to 10 mole % of perfluoromethyl vinyl ether and/or perfluoropropyl vinyl ether are used.

20. Process according to claim 1, wherein the copolymerisation is performed in a batch mode.

21. Process according to claim 1, wherein organic initiator is selected from a group consisting of azo compounds, dialkyl peroxydicarbonates, alkyl peroxides, alkyl hydroperoxides, t-alkyl perbenzoates and t-alkyl peroxypivalates.

22. Process according to claim 1, wherein the organic initiator is selected from the group consisting of the acetylcyclohexanesulfonyl peroxide, dibenzoyl peroxide, dicumyl peroxide, diethyl peroxydicarbonate, di-isopropyl peroxydicarbonate, t-butyl peroxypivalate, t-amyl and t-butyl cyclohexyl peroxydicarbonate.

23. Process according to claim 1, wherein the molar ratio between the initiator and the monomers ranges from 0.1 to 2%.

24. Process according to claim 1, wherein the copolymerisation is conducted in emulsion.

25. Process according to claim 24, wherein the copolymerisation is realised in presence of a surfactant in amounts varying usually from 1 to 3 weight %.

26. Process according to claim 25, wherein the surfactant is anionic, cationic or non ionic.

27. Process according to claim 1, wherein the copolymerisation is performed in presence of chain transfer agents.

28. Fluorinated elastomers comprising a vinylidene fluoride copolymer of vinylidene, at least one perfluorinated vinyl ether and optionally a fluorinated alkene, characterised in that it comprises neither tetrafluoroethylene, nor siloxane groups and presents low glass transition temperatures (T_{g}) between −35 and −42° C.

29. Fluorinated elastomers according to claim 28, comprised of vinylidene fluoride and perfluoromethyl vinyl ether and/or perfluoropropyl vinyl ether.

30. Fluorinated elastomers according to claim 29, comprising from 60 to 90 mole % of vinylidene fluoride (VDF) and from 40 to 10 mole % of perfluoromethyl vinyl ether (PMVE) and/or of perfluoropropyl vinyl ether (PPVE).

31. Seals, hose connections, tubes, diaphragms for automotive, mine, aeronautical, oil, electronic and clock-making as well as for nuclear industries and for the plastics industry, products for the forming of objects, made of elastomers mix of types according to claims 28 to 30.
